(19) United States
(12) Patent Application Publication
(10) Pub. No.: US 2012/0273503 A1
(43) Pub. Date: Nov. 1, 2012

(54) MODULAR SHAKER

(76) Inventor: Chih-Cheng YEN, Singapore (SG)

(21) Appl. No.: 13/097,065

(22) Filed: Apr. 29, 2011

(51) Int. Cl. A47J 43/27; B01F 11/00; B65D 81/38

(52) U.S. Cl. 220/568; 220/592.16; 220/592.2

(57) ABSTRACT

A modular container having first and second portions is presented. The first portion includes a first mating segment and the second portion which serves as a containing unit also includes a second mating segment. The first and second portions, when mated at the mating segments, are temporarily mated to form a sealed container. At least one of the first and second portions includes an inner wall component and an outer wall component. The outer wall component slidably fits over the inner wall. The modular container further includes a first locking member. When the locking member is engaged, the inner and outer wall components are locked in position to form a double-walled portion, and removing the locking members enables the inner and outer wall components to be separated.

### BACKGROUND

Shakers, such as cocktail shakers, are used, for example, to make mixed drinks. A shaker includes a bottom container for holding the ingredients, which may include liquids and solids, and an opposing container that acts as a top cover and fits snugly over the bottom container to ensure that no leakage occurs when the drink is prepared. When using a shaker, ice is added prior to the mixing process to bring the temperature of the contents within the shaker to a desired level. The temperature of the contents is cooled rapidly during the mixing process by agitating the shaker vigorously.

### SUMMARY

A modular container or shaker is disclosed. The modular container includes first and second portions. The first portion includes a first mating segment and the second portion, which serves as a containing unit, also includes a second mating segment. The first and second portions, when mated at their respective mating segments, are temporarily mated to form a sealed container. At least one of the first and second portions includes an inner wall component and an outer wall component. The outer wall component slidably fits over the inner wall component. The modular container further includes a first locking member. When the locking member is engaged, the inner and outer wall components are locked in position to form a double-walled portion, and removing the locking members enables the inner and outer wall components to be separated.

These embodiments, along with other advantages and features herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

FIGS. 1a-b show full and sectional views of an embodiment of a shaker with the top portion inserted into the bottom portion.

FIG. 2 is a perspective view of an embodiment of a disassembled shaker.

FIG. 3 is a perspective view of another embodiment of a disassembled shaker.

FIGS. 4a-b show sectional views of an unassembled and assembled embodiment of the top portion of a shaker.

FIG. 4c is a detailed sectional view of a portion of an embodiment of the top portion of a shaker.

FIGS. 5a-b show sectional views of an unassembled and assembled embodiment of the bottom portion of a shaker.

FIG. 5c is a detailed sectional view of a portion of an embodiment of the bottom portion.

### DETAILED DESCRIPTION

Embodiments generally relate to a modular container or shaker. The modular shaker can easily be assembled and disassembled for use. For example, the shaker may be used in bars, restaurants or in the home for making mixed drinks, including alcoholic or non-alcoholic mixed drinks. Other uses for the modular shaker may also be useful. For example, the shaker may be used generally for mixing elements to form a liquid or viscous solution.

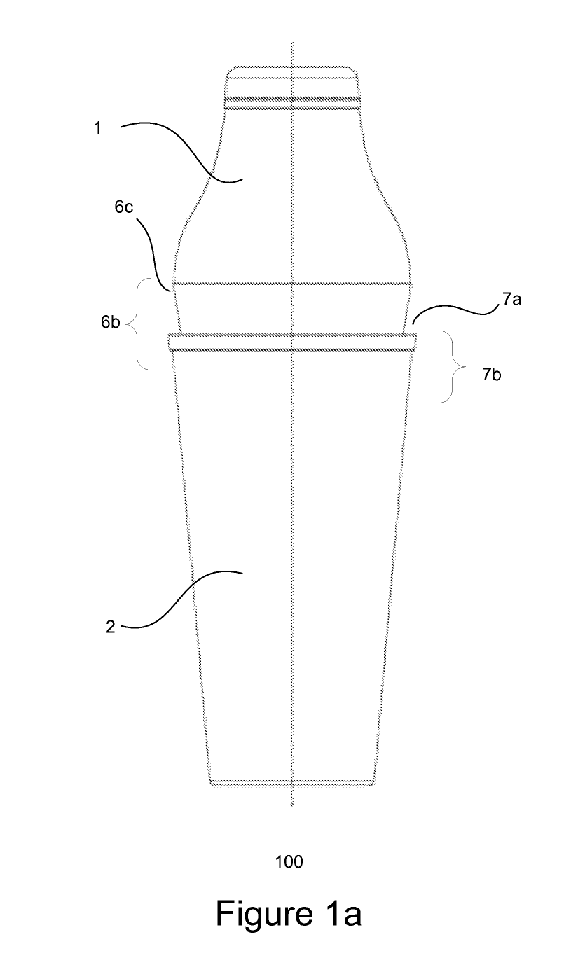

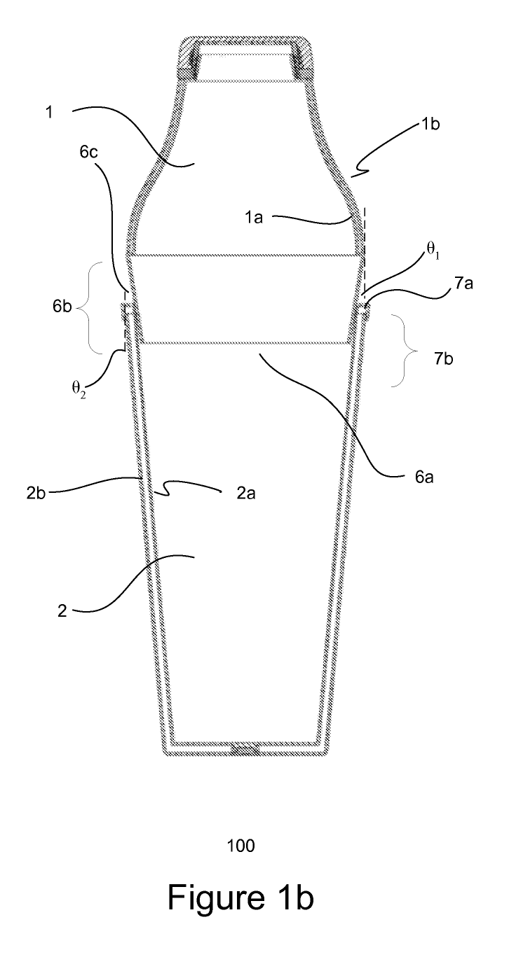

FIG. 1a shows an embodiment of a shaker 100. FIG. 1b shows a corresponding sectional view of the shaker. Referring to FIGS. 1a-b, the shaker as shown is assembled. The shaker includes a first or top portion 1 and second or bottom portion 2. The first and second portions, as shown, are temporarily mated together. The mating includes one of the portions fitting into the other portion to form a snug fit. The snug fit, for example, is a liquid tight fit to prevent contents within the shaker from spilling out during shaking.

The portion which fits into the other portion includes a first mating segment while the other portion includes a second mating segment. The first mating segment includes an outer circumferential opening which is smaller than the inner circumferential opening of the second mating segment. In one embodiment, the mating segments are tapered. The tapering of the mating segments, for example, is constant to form a constant slope. In one embodiment, the first mating segment has a tapering angle θ₁ with respect to the direction of mating which is greater than the tapering angle θ₂ of the second mating segment. Other tapering angles for the segments may also be useful. The difference in tapering angles facilitates providing a snug fit between the two portions when mated. As for other segments or parts of the portions, they may have different angles or shapes as desired.

In one embodiment, the circumferential openings have a circular shape. Other types of geometric shapes for the circumferential openings may also be useful, so long as they facilitate a snug fit between the two portions. For example, a square shaped opening with rounded corners may be used.

As illustrated, the top portion 1 fits into the bottom portion 2. The first or top mating segment 6b has an outer circumferential opening 6a which is smaller than the inner circumferential opening 7a of the second or bottom mating segment 7b. The tapering angle θ₁ of the top mating segment is greater than θ₂ of the bottom mating segment to facilitate a snug fit between the top and bottom portions of the shaker.

In one embodiment, the bottom portion comprises a constant tapered angle from its top. In one embodiment, the bottom portion comprises a constant tapered angle beginning from the end portion of the bottom mating segment. A flat end portion of the bottom portion may be provided to allow the shaker to stand.

For the top portion, when having a conical shape, the conical shape tapers from the top mating segment. In one embodiment, the tapering of the top portion is narrower at the top end than at the mating end. The top end may be significantly narrower than the mating end. Other shapes for the top and bottom portions may also be useful. The overall shape of the shaker, in one embodiment, should be designed to permit it to be held comfortable using one or two hands. In other embodiment, shaker may be used in conjunction with an electro-mechanical shaking system. In such case, different shapes may be employed depending on the system requirements.

In one embodiment, the top end includes an opening for pouring the contents from the shaker. A cap may be provided to close the opening to prevent contents from spilling out during shaking. In other embodiments, the top end may be a closed top end. Other designs for the top portion of the shaker may also be useful.

As described, the top portion is designed to fit snugly into the bottom portion. In other embodiments, the bottom portion of the shaker may be designed to snugly fit into the top portion, and the first mating segment would have an outer circumferential opening which is larger than the inner circumferential opening of the second mating segment.

In one embodiment, at least one of the portions comprises a double walled design. In a double walled design, the portion includes inner and outer walls. The walls are, for example, separated by a space to provide insulation. A double walled design reduces or avoids condensation on the outer surface of the shaker, thereby improving handling of the shaker. At the same time, contents within the shaker can also be kept at the desired temperature because heat transfer is reduced due to the space between the walls. In some embodiments, insulation or a seal may be provided between the walls to improve insulation.

In one embodiment, at least the bottom portion comprises a double walled design. For example, the bottom portion of the shaker comprises inner and outer walls 2a-b. In other embodiments, the top portion comprises a double walled design having inner and outer walls 1a-b separated by a space. In yet other preferred embodiment, both top and bottom portions are double wall portions.

In one embodiment, the mating segment which fits into the other mating segment includes a single wall section. For example, when the portions are mated, a portion of the single-walled band 6c is exposed. The exposed portion of the single-walled band can advantageously permit the highly-skilled professional mixologist or bartender to tactilely gauge the temperature of the contents and decide how long to shake the contents within the shaker. For example, the temperature can be gauged by the amount of condensation at the single-walled band.

In one embodiment, the shaker comprises a plurality of components or units that are assembled to form a modular shaker. For example, inner and outer walls of a portion are separate components which can be easily fitted or assembled together using fasteners or locking members. In some cases, a fastener may be incorporated into a part of a functional element of a portion.

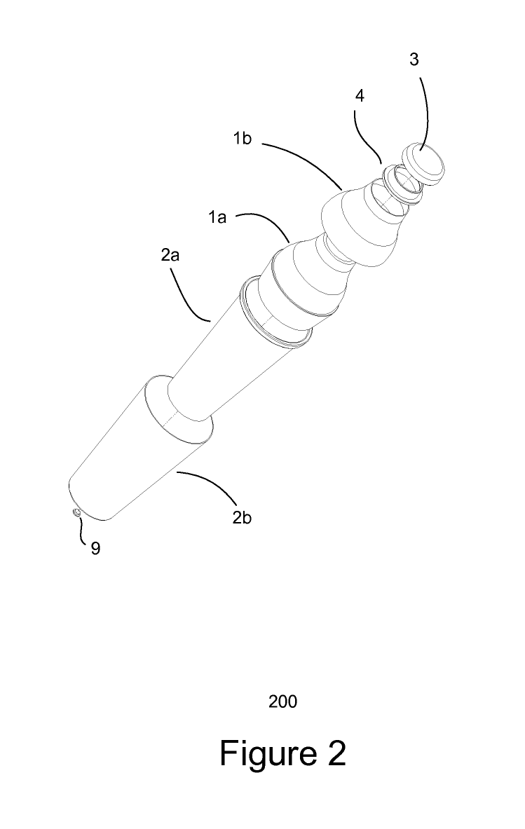

FIG. 2 shows modular constituent components or parts of an embodiment of the shaker 200. As shown, the components are disassembled. In one embodiment, the components include a removable cap 3, a first locking member 4, for example, a ring-shaped locking member, a first outer wall section 1b, a first inner wall section 1a, a second inner wall section 2a, a second outer wall section 2b and a second locking member 9. None of these constituent parts are permanently joined together, thereby allowing parts to be replaced or changed as needed. The various components form a shaker having top and bottom double-walled portions. In some embodiments, the top portion may be a single-walled portion while the bottom portion is a double-walled portion. Other configurations of components to form other types of shakers may also be useful. For example, the shaker may a first locking member 4 that has a closed end, when a removable cap is not required.

The first inner and outer wall sections are assembled to form the first or top portion of the shaker. The first wall sections comprise a cylinder or cylindrical shaped structure having first and second opened ends. The first end, for example, includes the first mating segment while the second end serves as a pour opening of the top portion. In one embodiment, the cylindrical shape of the wall sections may be circular with a conical profile which has different diameters at different parts of the section. The inner wall sections fits within the outer wall sections. It is understood that the shape of the inner wall and outer wall need not the same, so long as the inner wall can fit within the outer wall.

In one embodiment, the first outer wall section comprises a circular cylindrical or annular structure which forms a conical shape. For example, the outer wall section is wider or has a larger diameter at the first end, with an increasing taper to define the mating section, and decreasing towards the second end to form the pour opening. The change in diameter may be a constant gradient, a curved slope, an abrupt change, or a combination thereof. Providing other cylindrical shapes or profiles for the first outer wall section may also be useful. For example, the cylindrical shape may be oval or square.

The first inner wall section, in one embodiment, is fitted within the outer wall through the first or wider opening. The second end of the first inner wall extends through the first end of the first inner wall. In one embodiment, the first locking member is coupled to the second end of the first inner wall, fixing the wall sections in place to form a top doubled-walled portion of the shaker. The first locking member may be a ring shaped locking member. Other types of locking members may also be useful. The first outer wall section, in one embodiment, leaves the first mating section of the first inner wall exposed for mating with the bottom portion of the shaker.

In one embodiment, the first locking member may include a cap coupler, allowing a cap to be attached to the second end of the top portion. For example, the cap coupler, as shown, is provided with male threads for mating with female threads of the cap. Other types of cap couplers and caps may also be useful. For example, the cap coupler may be for a friction-mated cap and the male threads would not be required. Other types of cap couplers may also be employed for the cap and as a locking member for the top portion.

The second inner and outer wall sections are assembled to form the second or bottom portion of the shaker. The second wall sections comprise a cylinder or cylindrical shaped structure having a first opened end and a second closed end. The first end, for example, includes the second mating segment while the second closed end includes a flat surface, enabling the shaker to stand. In one embodiment, the cylindrical shape of the wall sections may be circular with a conical profile which has different diameters at different parts of the section. The inner wall section fits within the outer wall section. It is understood that the shape of the second inner and outer walls need not be the same, so long as the inner wall can fit within the outer wall.

In one embodiment, the second outer wall section comprises a circular cylindrical or annular structure which forms a conical shape. For example, the outer wall section is wider or has a larger diameter at the first end than the second end. For example, the second outer wall has a deceasing taper from the first end to the second end. The change in diameter may be a constant gradient, a curved slope, an abrupt change, or a combination thereof. In one embodiment, the change in diameter comprises a constant gradient. Providing other cylindrical shapes or profiles for the second outer wall section may also be useful. For example, the cylindrical shape may be oval or square. The second inner wall section comprises a cylindrical or annular structure. The shape of the inner wall may be similar to the outer wall section, but smaller to allow it to fit therein. Providing second inner and outer wall sections which have different shapes, so long as the inner wall section can fit within the outer wall section, may also be useful.

The second inner wall section, in one embodiment, is fitted within the outer wall through the first end. In one embodiment, the second locking member is provided to lock the second inner and outer wall sections in position to form a double walled bottom portion. The second locking member may be screw type fastener. The screw type fastener, for example, fits through the bottom or closed end of the second outer wall section and mates to the second inner wall section. Other types of locking members may also be useful.

The top and bottom portions can easily be disassembled by unlocking the locking members to separate the inner and outer wall sections. For example, the locking members may be unscrewed to separate the wall sections. This facilitates cleaning of the wall sections. Furthermore, the modular nature of the shaker allows any part damaged through mishandling or other mishaps to be individually replaced, thereby reducing waste. The modular construction also allows the outer walls to be interchanged to create customized versions of the shaker for different purposes, such as advertising or thematic conformity. Multiple outer covers with customized designs for outer walls can be interchangeably used.

The surfaces of the shaker that come into contact with the contents, in one embodiment, are made of stainless steel or other similarly inert metal. The outer wall sections can be made of stainless steel or, alternatively, light weight aluminum or plastic. Other types of materials may also be used to form the different wall sections. For some uses, it may be desirable to have the cup portion of the inner wall section of the bottom portion be made of glass. Furthermore, it is understood that the different wall sections or components of the shaker need not be formed from the same material.

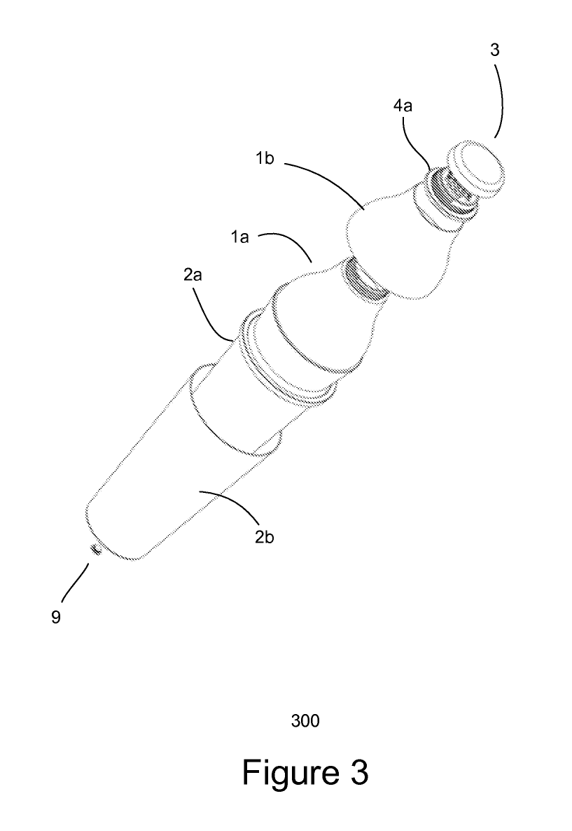

FIG. 3 shows modular constituent components or parts of another embodiment of the shaker 300. As shown, the components are disassembled. In one embodiment, the components are similar to those described in FIG. 2, except for the locking member 4a. In one embodiment, the locking member includes a strainer. The strainer includes a perforated plate made from material such as metal. Other types of materials and strainer designs may also be useful, such a wire mesh. The strainer is used to retain the solid contents, which are smaller than the openings of the strainer, within the shaker when removing the liquid contents.

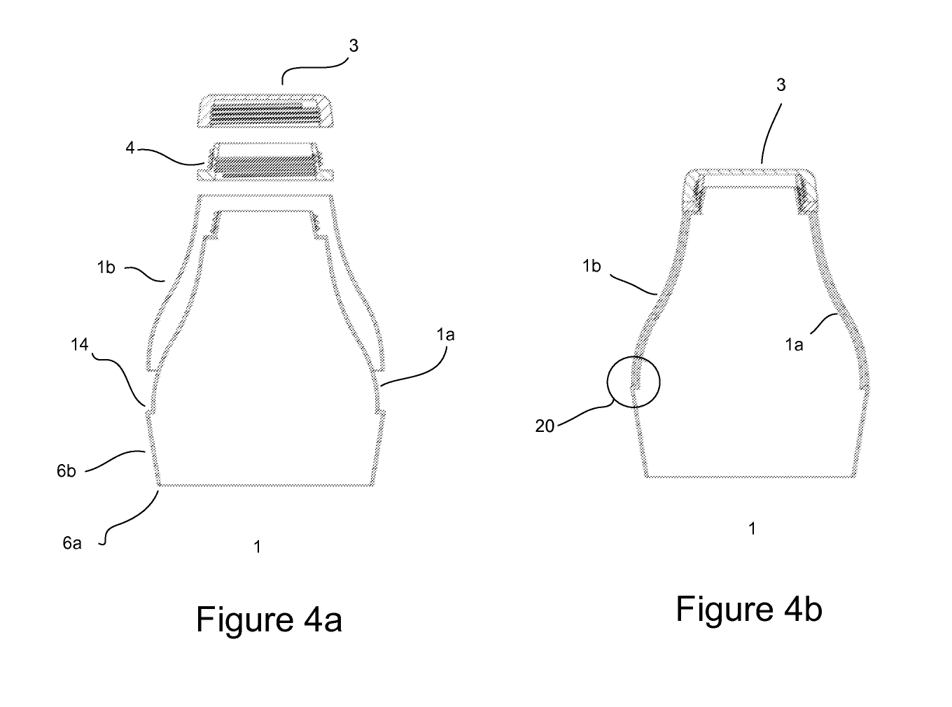

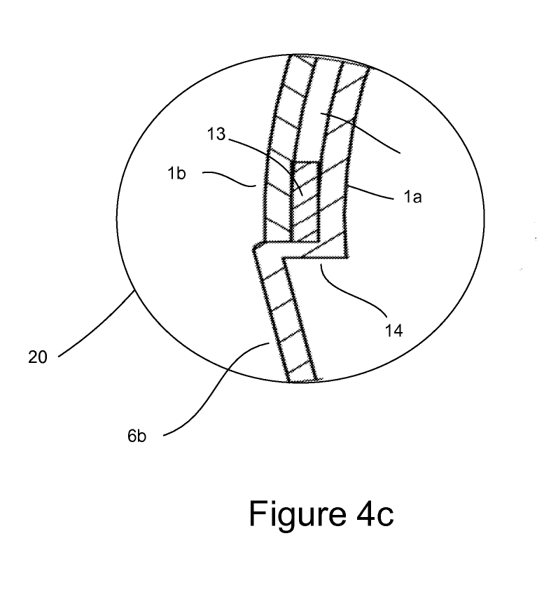

FIGS. 4a-b show cross-sectional views of an embodiment of a top portion 1 assembled and disassembled. Referring to FIGS. 4a-b, the first inner wall section 1a, in one embodiment, includes a hollow section. The first inner wall section 1a includes a first opening at a first end and a second opening at a second end. The second opening, for example, is smaller than the first opening, forming a conical shaped first inner wall section. For example, the inner wall section is an annular inner wall section. Providing other shapes for the first inner wall section may also be useful. In one embodiment, the first inner wall section extends conically upwards from the circumferential edge 6a and forms a flange 14. The segment of the first inner wall section from the outer circumferential edge or opening to the flange forms the first mating segment 6b.

Assembly to form the top portion includes sliding the first outer wall section 1b over the first inner wall section 1a. For example, the first end of the first outer wall section slides over the second end of the first inner wall section. In one embodiment, the first end of the first outer section opening section abuts the flange. The flange, for example, supports the first outer wall section. In some embodiments, the first end of the outer wall section may include a matching outer flange to overlap the flange or inner flange of the first inner wall section. The second end of the first inner wall section extends beyond the second end of the first outer wall section. For example, the second end of the inner wall section may form an end for mating with a female end of the first outer wall section.

A first locking member 4, in one embodiment, is fitted to the second end of the first inner wall section. The first locking member, for example, may be a ring shaped locking member which fits over the second end of the first inner wall section. In one embodiment, the second end of the first inner wall section may include threading and the locking member may include female threading for mating. Other types of mating between the locking member and the second end of the first inner wall section may also be useful. For example, twist and lock mating or friction mating may also be employed. When mated, the locking member locks the first wall sections in place to form a double-walled top portion of the shaker.

FIG. 4c shows a detailed view of a portion 20 of the top portion of the shaker. As shown, a space 11 is created between the first wall sections when the top portion is fully assembled. This insulating space may be filled with a layer of insulating material, such as polystyrene foam or cork, for improved insulation performance. Other insulating materials may also be used. In other embodiment, the insulating space may be unfilled and, to provide a sealed or substantially sealed space between the wall sections, a seal may be disposed between the ends of the wall sections. In one embodiment, a sealing member is disposed between the first ends of the wall sections. Providing an additional seal at the second ends may also be useful.

In one embodiment, the sealing member 13 is disposed in a portion between the first wall sections. The sealing member, such as a gasket or O-ring, may be used to improve the insulating quality of the top portion of the shaker, as well as to provide added stability for the first outer wall section. Other types of sealing member may also be used. The sealing member 13 may be pre-position at the flange 14, or above the flange and allowed to slide down as it comes into contact with edge of the first outer wall section until they both sit on the flange.

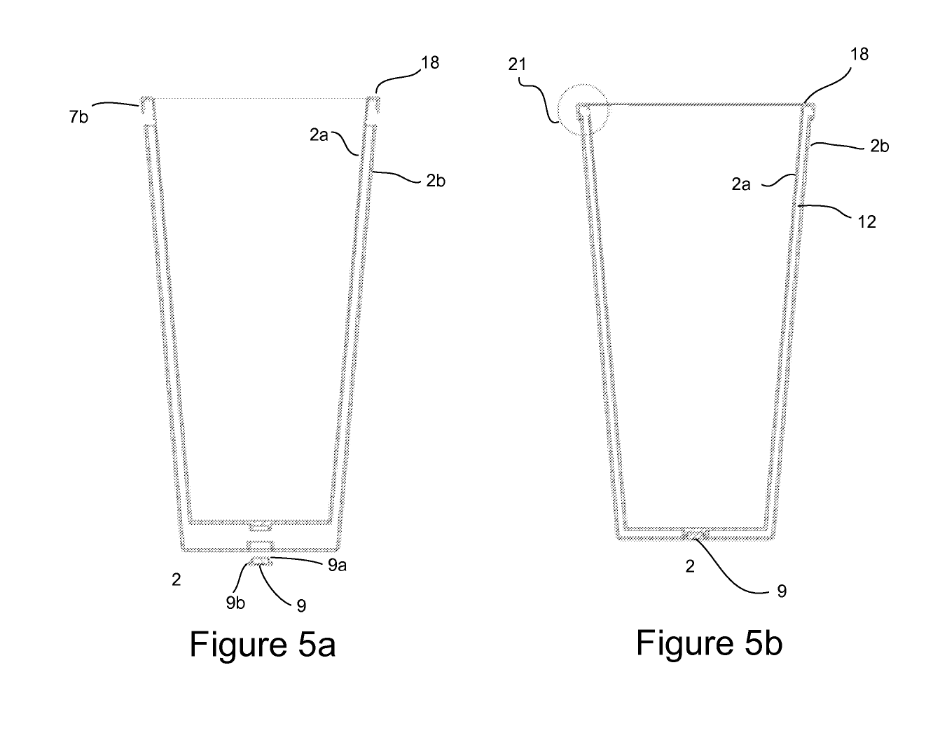

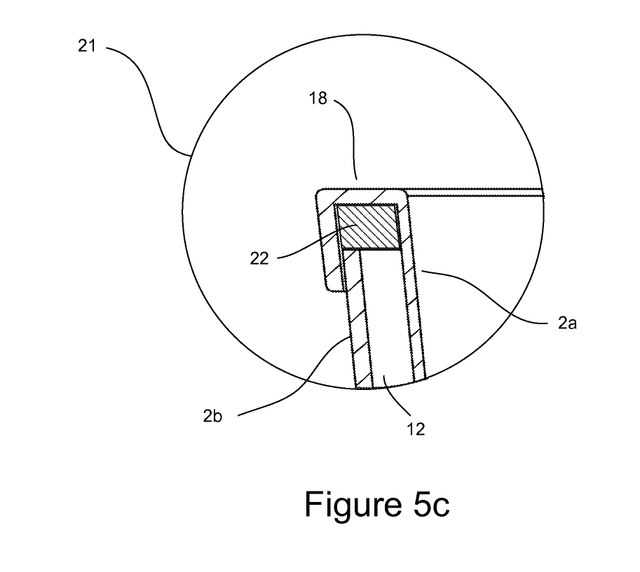

FIGS. 5a-b shows cross-sectional views of an embodiment of a bottom portion 2 assembled and disassembled. Referring to FIGS. 5a-b, the second outer wall section 2b, in one embodiment, includes a cylindrical structure having a first opened end and a second closed end. The closed end, for example, includes a flat surface to enable the bottom portion to stand upright on the second end. In one embodiment, the first end is larger than the second end, producing a conical shaped second outer wall section. Providing other shapes for the second outer wall section may also be useful. The shape of the second outer wall section should be designed to facilitate ease of being held for shaking.

In one embodiment, the second inner wall section 2a has a similar shape as the second outer wall section, except that it is smaller to enable it to fit within the outer wall section. Providing outer and inner wall sections having different shapes may also useful. In one embodiment, the inner surface of the second inner wall at about the first opening includes a second mating segment 7b for mating with the first mating segment of the top portion.

A flange 18 which extends outwardly from the first end of the second inner wall section may be provided. The flange, for example, is a grooved flange designed to support or mate with the first end of the second outer wall section. For example, the first end of the second outer wall section fits within the grooved flange of the second inner wall section.

Assembly to form the bottom portion includes sliding the second outer wall section over the second inner wall. For example, the second end of the second inner wall section slides through the first end of the second outer wall section. In one embodiment, the first ends of the second outer wall section fit within the flange of the second inner wall section. A second or bottom locking member 9, in one embodiment, is provided. When the second locking member is engaged, it holds the inner and outer wall sections in place, forming a double walled bottom portion. Disengaging the locking member enables the inner and outer wall sections to be separated.

In one embodiment, the second locking member is disposed on the second end of the bottom portion. Providing the second locking member at other locations or more than one locking members may also be useful. The second locking member, for example, may be a locking pin or a screw. Other type of second locking members may also be useful. The second locking member, for example, includes a body 9a and a head 9b. The cap includes a larger surface area than the body. The body may fit through an opening on the second end of the second outer wall section for mating with second end of the second inner wall section. When the locking member is engaged, the head contacts the second end of the second outer wall section, fixing it in position with respect to the second inner wall section.

As shown, a space 12 is created between the second wall sections when the bottom portion is fully assembled. This insulating space may be filled with a layer of insulating material, such as polystyrene foam or cork, for improved insulation performance. Other insulating material may also be used. In other embodiment, the insulating space may be unfilled. To provide a sealed or substantially sealed space between the wall sections, a seal may be disposed between the ends of the wall sections. In one embodiment, although not shown, a sealing member may be disposed between the second wall sections adjacent to or at the flange 21.

FIG. 5c shows a detailed view of a portion or the flange area 21 of the bottom portion when the second wall sections are mated together. When assembled, the upper circumferential edge of the second outer wall section will insertably meet the grooved flange 18. In one embodiment, a friction fit is formed between the grooved flange and second outer wall section. In one embodiment, the grooved flange is an integral extension of the second inner wall section. For example, the second inner wall section including the grooved flange which forms the cup portion can be made from a single sheet of material, such as stainless steel. Other types of material may also be useful.

In one embodiment, a sealing member 22 is disposed between the inner and outer wall sections at the flange area. The sealing member, such as a gasket or O-ring, may be used to improve the insulating quality of the top portion of the shaker, as well as to provide added stability for the second outer wall section. Other types of sealing member may also be used. The sealing member 22 may be pre-position at the flange, or below the flange and allowed to upwards as it comes into contact with edge of the second outer wall section until they both sit on the flange.

It will be understood that various details of the invention may be changed without departing from the scope of the invention. Furthermore, the foregoing description is for the purpose of illustration only, and not for the purpose of limitation—the invention being defined by the claims.

What is claimed is:

1. A modular container comprising:
a first portion, the first portion includes a first mating segment; and
a second portion serving as a containing unit, the second portion includes a second mating segment, wherein the first and second portions are temporarily mated, at the first and second mating segments, to form a sealed container,
at least one of the first and second portions comprises
an inner wall component,
an outer wall component, wherein the outer wall component slidably fits over the inner wall, and
a first locking member, wherein when the locking member is engaged, the inner and outer wall components are locked in position to form a double-walled portion, and wherein removing the locking member enables the inner and outer wall components to be separated.

2. The modular container according to claim 1, wherein when the outer wall component slidably fits over the inner wall, an insulating space is formed between the inner and outer wall components.

3. The modular container according to claim 1, wherein the locking member comprises a ring shaped locking member.

4. The modular container according to claim 3, wherein the locking member includes a cap coupler having at least one threaded segment.

5. The modular container according to claim 4 further comprises a cap being coupled to the cap coupler.

6. The modular container according to claim 1, wherein the locking member comprises a locking pin.

7. The modular container according to claim 6, wherein the locking member includes a body and a cap.

8. The modular container according to claim 1, wherein the locking member comprises a strainer.

9. The modular container according to claim 1, wherein the inner wall component extends conically upwards from a circumferential edge to form a flange.

10. The modular container according to claim 9, wherein a first end of the outer wall component abuts the flange.

11. The modular container according to claim 9 further comprises a sealing member being located at the flange.

12. The modular container according to claim 1, wherein the first mating segment or the second mating segment includes a single wall.

13. The modular container of claim 1, wherein the first portion is on top of the second portion.

14. A modular container comprising:
a first portion, the first portion includes a first mating segment; and
a second portion, the second portion includes a second mating segment, wherein the first and second portions, when mated at the mating segments, are temporarily mated to form a sealed container,
at least one of the first and second portions comprises
an inner wall component,
an outer wall component, wherein the outer wall component slidably fits over the inner wall, and
a first locking member, wherein when the locking member is engaged, the inner and outer wall components are locked in position to form a double-walled portion, and wherein removing the locking member enables the inner and outer wall components to be separated.

15. The modular container according to claim 14, wherein the inner wall component includes a flange which extends outwardly from a first end of the inner wall component.

16. The modular container according to claim 14, wherein the flange includes a grooved flange.

17. The modular container according to claim 14, wherein the locking member comprises a locking pin.

18. The modular container according to claim 14, wherein the locking member includes a body and a cap.

19. The modular container according to claim 14 further comprises a sealing member disposed between the inner and outer wall components at the flange.

20. The modular container according to claim 14, wherein the second portion is on top of the first portion.
